(19) United States
(12) Patent Application Publication
(10) Pub. No.: US 2007/0157128 A1
(43) Pub. Date: Jul. 5, 2007

(54) Efficient control of calendar information in computer graphics

(76) Inventor: Tobias Haug, Heidelberg (DE)

Correspondence Address: KENYON & KENYON LLP, 1500 K STREET N.W., WASHINGTON, DC, 20005, US

(21) Appl. No.: 11/321,740

(22) Filed: Dec. 30, 2005

(51) Int. Cl. G06F 3/00

(52) U.S. Cl. 715/963; 715/771

(57) ABSTRACT

Embodiments relate to a method and system for providing calendar controls in computer displays in a compact, uncluttered format. According to the embodiments, multiple calendar control functions are brought together in a streamlined graphical design that conserves space and minimizes the number of manual operations needed

### BACKGROUND OF THE INVENTION

Calendars appear in many computer applications. However, often, calendar displays can be cluttered and use of the calendars can be laborious. FIG. 1 shows one example of a generic calendar display that illustrates some of the drawbacks in the prior art. The calendar display 100 has separate controls 101, 102 and 103 for defining/displaying a time span, a month and a year, respectively. This kind of arrangement occupies too much space and requires too many manual operations to be convenient. Improvement is called for.

### BRIEF DESCRIPTION OF THE DRAWINGS

FIG. 1 shows an example of a prior art calendar control graphic;

FIGS. 2A, 2B, 3 and 4 show examples of calendar control graphics according to embodiments of the present invention;

FIG. 5 shows a system according to embodiments of the present invention; and

FIGS. 6 and 7 show processes according to embodiments of the present invention.

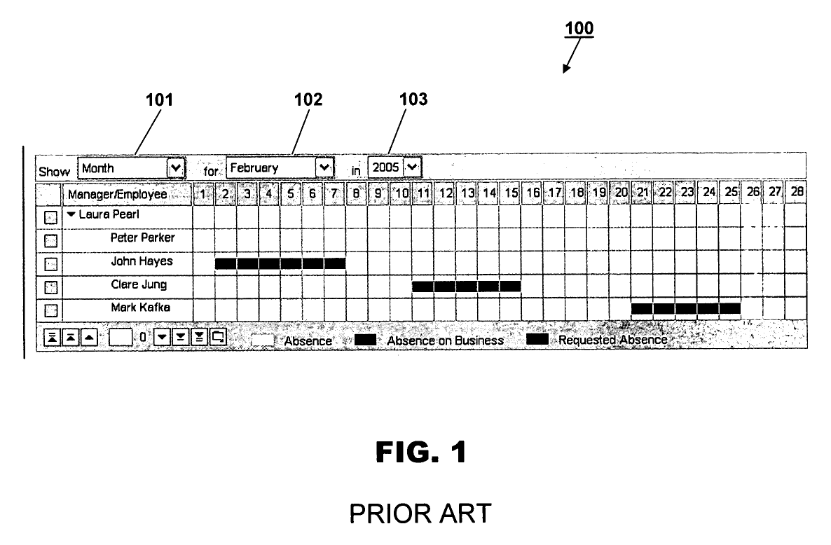

### DETAILED DESCRIPTION

Embodiments of the present invention address the above-described concerns. The embodiments relate to a method and system for providing calendar controls in a compact, uncluttered format. According to the embodiments, multiple calendar control functions are brought together in a streamlined graphical design that conserves space and minimizes the number of manual operations needed

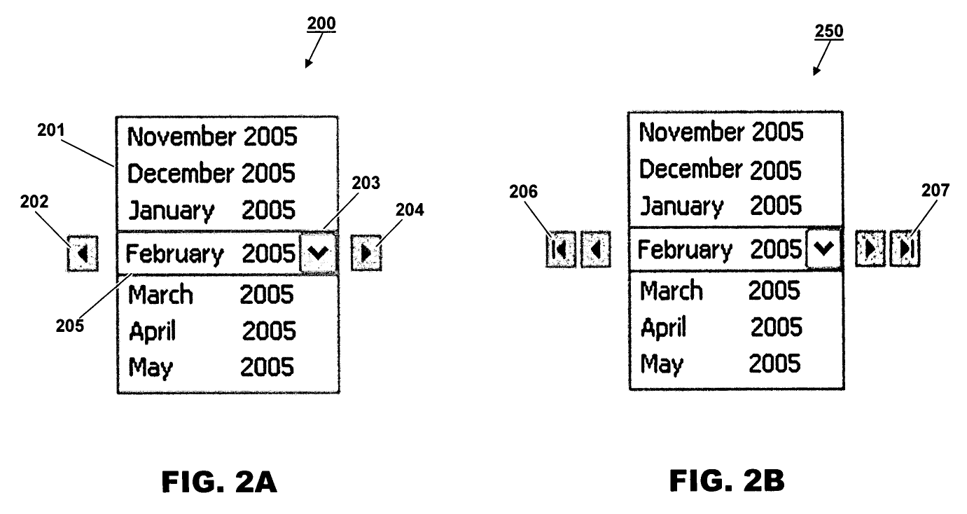

FIG. 2A shows a computer display 200 for calendar control according to embodiments of the present invention. The display 200 of FIG. 2A includes a compact time range window 201 with associated controls 202, 203 and 204, and an internal shifting or sliding window 205.

By activating them with an input device (e.g., clicking on them with a mouse), controls 202, 203 and 204 can be used to navigate through calendar information. Control 203 is a scrolling control by which a selection of a month in window 201 may be made. The sliding window 205 tracks the selection made. Left and right sequential controls 202 and 204, respectively, may be activated to cause a jump to a previous and a subsequent month, respectively. The size of the time range window 201 can be adjusted as desired, i.e., to include as many or as few months (or years, or whatever unit of time is concerned) as a user finds convenient. The time range window 201 may operate in a scrolling fashion; i.e., when the user tries to access a month outside the currently displayed range using the scrolling control 203 or left or right sequential controls 202 and 204, the months displayed in the window 201 may shift accordingly, e.g. from May 2005 through November 2005 to April 2005 through December 2005. Once a given month is selected, an actual calendar of the days in the month may be displayed.

FIG. 2B shows an embodiment of the present invention similar to that of FIG. 2B, but with additional controls. The embodiment of FIG. 2B includes large interval jump controls 206 and 207 for jumps from the currently selected date of a predefined, fixed interval larger than the currently-displayed time unit (e.g. months in FIG. 2B). The interval could be, for example, one year. Thus, by clicking once on the right jump control 207, a jump to February 2006 may be performed. Similarly, by clicking once on the left jump control 206, a jump to February 2005 may be performed.

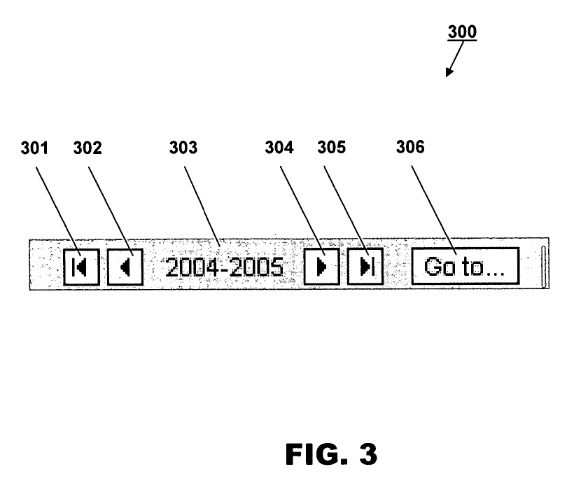

FIG. 3 shows another computer display 300 for calendar control according to embodiments of the present invention. Display 300 is formatted as a control bar comprising navigation controls 301, 302 and 304-306. The controls may apply to a time range 303. Range controls 301 and 305 may be activated to adjust the time range by the unit concerned. For example, when the unit is years as in the example of FIG. 3, the left range control 301 may be used to scroll the time range backwards sequentially by one or more years. Thus, by clicking once on the left range control 301, the time range 303 may be changed from “2004-2005” to “2003-2004”; by clicking twice on the left range control 301, changed from “2004-2005” to “2002-2003”, and so on. Similarly, by clicking on the right range control 304, the time range 303 may be scrolled sequentially forward, e.g. from “2004-2005” to “2005-2006”, and so on. The “Go to” control 306 may be used to jump directly to a selected time without going there sequentially; e.g., by clicking on the “Go to” control 306 and entering a specific year, a user could jump directly to, say, 1972.

Left and right sub-unit controls 302 and 304 may be used to scroll sequentially backward and forward, respectively, by sub-units within the range 303. For example, clicking on the right sub-unit control 304 may cause a range “Jan-Dec” to change to “Feb-Jan”. Clicking on the left sub-unit control 302 may cause a range “Jan-Dec” to change to “Dec-Nov”, and so on.

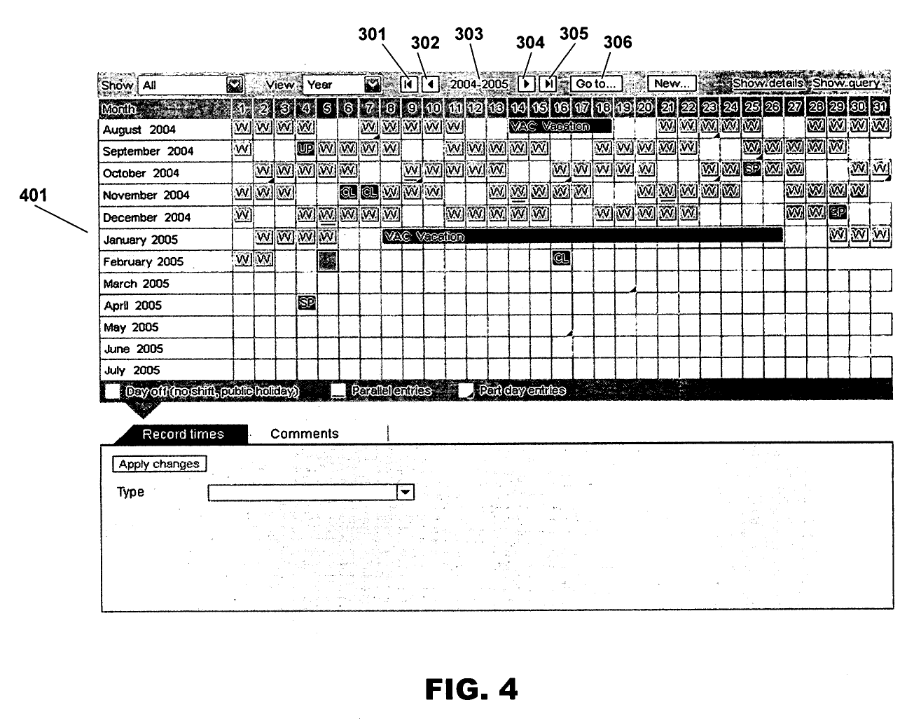

FIG. 4 shows the calendar controls 300 together with an actual calendar 401. In the calendar, a time range 2004-2005 is defined, and months August 2004 through July 2005 are currently displayed. By clicking once on the right sub-unit control 304, the currently-displayed months could be shifted to September 2004 through July 2005; by clicking twice, shifted to October 2004 through August 2005, and so on. Similarly, by clicking once on the left sub-unit control 302, the currently-displayed months could be shifted to July 2004 through June 2005; by clicking twice, shifted to June 2004 through July 2005, and so on.

The time range 303 of the calendar controls 300 may be changed dynamically, and the displayed calendar and sub-units of the range, and corresponding scrolling control, may change accordingly. For example, the time range could be changed to, say, “March-April” or “June-August”, and the calendar 401 would be truncated to a month in the first case, or three months in the second case. The time range could even be changed to cover only days or weeks, and the sub-units might then automatically change to days of the week by name (i.e., “Monday”, “Tueday”, “Wednesday”, etc.) and/or hours of the day.

A computer display with calendar control graphics as described above may be implemented, for example, at least in part by computer-executable instructions according to embodiments of the present invention. The instructions may generate, possibly in association with conventional code that controls aspects of a display's appearance, a display on a display device, where the display includes a scrollable time range window comprising a plurality of time units, and sequential jump controls to jump from a currently-selected time unit to a previous or subsequent time unit, as shown in FIG. 2A. The display may further include large interval jump controls to jump a predefined interval larger than a currently-displayed unit, as shown in FIG. 2B.

In embodiments, the instructions may generate, possibly in association with conventional code that controls aspects of a display's appearance, a display on a display device, where the display comprises a control bar with a plurality of navigation controls, including time range controls to scroll a time range forward and backward, sub-unit controls to scroll forward and backward by sub-units within the time range, a time interval, and a go-to control to jump directly to a selected time, as shown in FIG. 3.

The instructions according to embodiments of the present invention, or conventional code that interfaces with the instructions, may receive input signals from a mouse, keyboard or other input device and perform corresponding operations. Such signals may be interactive events that the instructions, or conventional code that interfaces with the instructions, are responsive to. For example, a user may activate a control as shown in FIGS. 2A, 2B and 3 by clicking on it with a mouse or performing one or more keystrokes. Such operations may generate signals to the instructions, or conventional code that interfaces with the instructions. In response to the signals, the instructions, or conventional code that interfaces with the instructions, may perform an operation corresponding to the activated control.

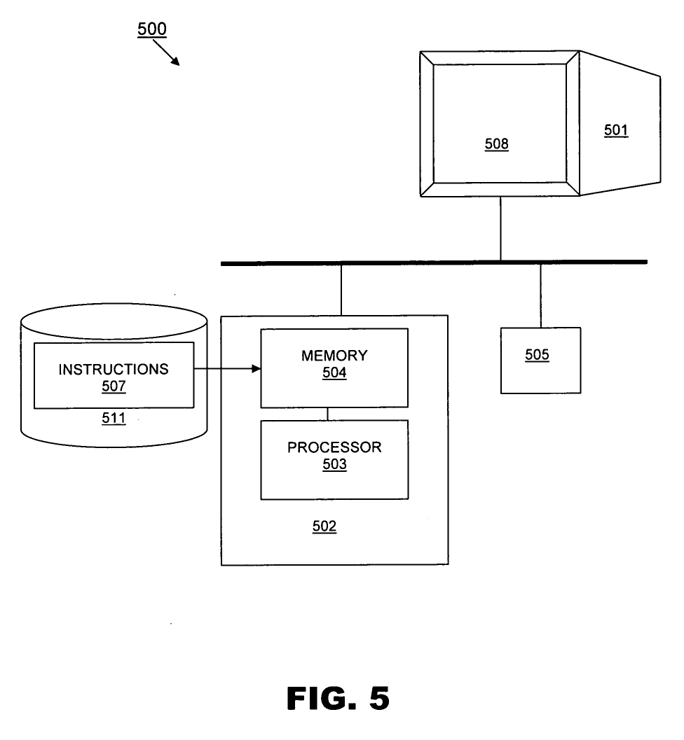

FIG. 5 shows a system 500 wherein embodiments of the present invention may find advantageous application. The system 500 may comprise a display device 501. The display device 501 may be coupled to a computer 502 comprising a processor 503 and memory 504. The computer 502 may further be coupled to an input device 505 such as a mouse or keyboard.

Computer-executable instructions 507 according to embodiments of the present invention may be stored on any machine-readable medium 511, such as RAM (random access memory), ROM (read-only memory), floppy disk, fixed disk, CD-ROM, magnetic tape and the like. The instructions may be loaded from the machine-readable medium 511 into the memory 504 for execution by the processor 503. As noted previously, the instructions may interface with conventional code that controls aspects of a display's appearance.

The instructions 507, or conventional code that interfaces with the instructions 507, may generate a display 508 on the display device 501. The display 508 may include one or more calendar control graphics according to embodiments of the present invention. With the input device 505, a user may select or activate controls within the calendar control graphics. This may generate interactive events, such as signals from the input device 505 that are detected by the computer 502. The instructions 507, or conventional code that interfaces with the instructions 507, may be responsive to the signals detected by the computer 502 to perform an operation corresponding to an activated control.

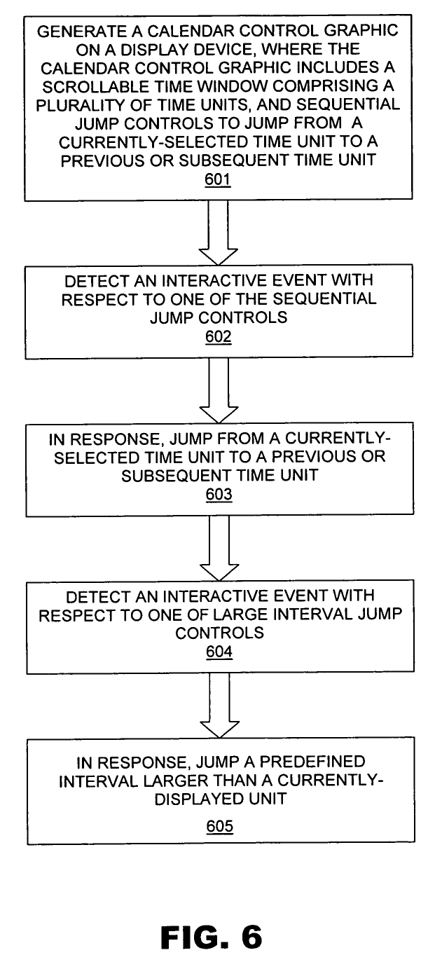

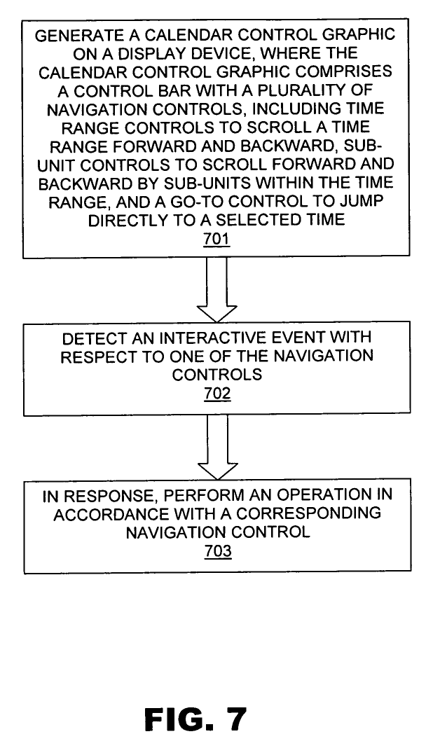

FIGS. 6 and 7 show processes according to embodiments of the present invention. As shown in block 601 of FIG. 6, the process illustrated therein may include generating a calendar control graphic on a display device, where the calendar control graphic includes a scrollable time range window comprising a plurality of time units, and sequential jump controls to jump from a currently-selected time unit to a previous or subsequent time unit. As shown in block 602, the process may further include detecting an interactive event with respect to one of the sequential jump controls. In response, a jump may be performed from a currently-selected time unit to a previous or subsequent time unit, as shown in block 603.

The calendar control graphic may further include large interval jump controls to jump a predefined interval larger than a currently-displayed unit. Accordingly, the process of FIG. 6 may further comprise detecting an interactive event with respect to one of the large interval jump controls, as shown in block 604, and in response, jumping a predefined interval larger than a currently-displayed unit as shown in block 605.

A process as illustrated in FIG. 7 may include, as shown in block 701, generating a calendar control graphic on a display device, where the calendar control graphic comprises a control bar with a plurality of navigation controls, including time range controls to scroll a time range forward and backward, sub-unit controls to scroll forward and backward by sub-units within the time range, and a go-to control to jump directly to a selected time. As shown in block 702, the process may further comprise detecting an interactive event with respect to one of the navigation controls. In response, an operation in accordance with a corresponding navigation control may be performed, as shown in block 703.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A machine-readable medium storing instructions for calendar control, the instructions to:
generate a scrollable time range window including a plurality of time units; and
generate sequential jump controls to jump from a currently-selected time unit to a previous or subsequent time unit.

2. The machine-readable medium of claim 1, wherein the size of the time range window is adjustable.

3. The machine-readable medium of claim 1, the instructions further to generate large interval jump controls to jump a predefined interval larger than a currently-displayed unit.

4. The machine-readable medium of claim 1, wherein the time unit is months.

5. The machine-readable medium of claim 1, wherein the time unit is years.

6. A machine-readable medium storing instructions for calendar control, the instructions to generate a control bar with a plurality of navigation controls, including:
time range controls to scroll a time range forward and backward;
sub-unit controls to scroll forward and backward by sub-units within the time range; and
a go-to control to jump directly to a selected time.

7. The machine-readable medium of claim 6, wherein the control bar further includes a display of a time range.

8. The machine-readable medium of claim 6, wherein the control bar is associated with a calendar.

9. The machine-readable medium of claim 6, wherein the time range is a year.

10. The machine-readable medium of claim 9, wherein the sub-units are months.

11. A method comprising:
generating a calendar control graphic on a display device, the calendar control graphic including a scrollable time range window comprising a plurality of time units, and sequential jump controls to jump from a currently-selected time unit to a previous or subsequent time unit;
detecting an interactive event with respect to one of the sequential jump controls; and
in response, jumping from a currently-selected time unit to a previous or subsequent time unit.

12. The method of claim 11, wherein the calendar control graphic further includes large interval jump controls to jump a predefined interval larger than a currently-displayed unit, and the method further comprises:
detecting an interactive event with respect to one of the large interval jump controls; and
in response, jumping a predefined interval larger than a currently-displayed unit.

13. The method of claim 12, wherein the sequential jump controls and large interval jump controls are arranged to either side of the time range window in approximately a central part thereof.

14. A machine-readable medium storing instructions to perform a method according to claim 11.

15. A method comprising:
generating a calendar control graphic on a display device, the calendar control graphic including a control bar with a plurality of navigation controls, including time range controls to scroll a time range forward and backward, sub-unit controls to scroll forward and backward by sub-units within the time range, and a go-to control to jump directly to a selected time;
detecting an interactive event with respect to one of the navigation controls; and
in response, performing an operation in accordance with a corresponding navigation control.

16. The method of claim 15, wherein the navigation controls are all arranged along a same line.

17. A machine-readable medium store instructions to perform method according to claim 15.

18. A system comprising:
a display device; and
a computer coupled to the display device, the computer to generate a display on the display device, the display including a calendar control graphic comprising a scrollable time range window including a plurality of time units, and sequential jump controls;
wherein the sequential jump controls are responsive to an interactive event to jump from a currently-selected time unit to a previous or subsequent time unit.

19. The system of claim 18, wherein the calendar control graphic further includes large interval jump controls responsive to an interactive event to jump a predefined interval larger than a currently-displayed unit.

20. A system comprising:
a display device; and
a computer coupled to the display device, the computer to generate a display on the display device, the display including a calendar control graphic comprising a control bar with a plurality of navigation controls, including time range controls to scroll a time range forward and backward, sub-unit controls to scroll forward and backward by sub-units within the time range, and a go-to control to jump directly to a selected time;
wherein the navigation controls are responsive to an interactive event to perform an operation in accordance with a corresponding navigation control.
